(19) United States
(12) Patent Application Publication
(10) Pub. No.: US 2025/0141218 A1
(43) Pub. Date: May 1, 2025

(54) METHOD AND APPARATUS FOR LIMITING LIGHTNING OVERVOLTAGE OF DIRECT-CURRENT POWER TRANSMISSION LINE

(71) Applicant: WUHAN NARI LIMITED LIABILITY COMPANY OF STATE GRID ELECTRIC POWER RESEARCH INSTITUTE, Wuhan (CN)

(72) Inventors: Shanqiang Gu, Wuhan (CN); Jian Wang, Wuhan (CN); Shuai Wan, Wuhan (CN); Wei Cao, Wuhan (CN); Jian Li, Wuhan (CN); Zhe Li, Wuhan (CN); Yuhe Fang, Wuhan (CN); Chun Zhao, Wuhan (CN); Xin Liu, Wuhan (CN); Zihao Liu, Wuhan (CN)

(21) Appl. No.: 19/004,444

(22) Filed: Dec. 29, 2024

Related U.S. Application Data
(63) Continuation of application No. PCT/CN2022/141786, filed on Dec. 26, 2022.

(30) Foreign Application Priority Data
Dec. 21, 2022 (CN) 202211648056.9

(51) Int. Cl. H02H 9/04; H01C 8/04

(52) U.S. Cl. CPC H02H 9/042; H01C 8/04

(57) ABSTRACT

The present invention belongs to the technical field of lightning protection of power transmission lines, and in particular, relates to a method for limiting lightning overvoltage of a direct-current power transmission line. By means of using operation date of a line itself, lightning current monitoring data, and parameters of an environment where the line is located, a line dynamic operation function curve and a line lightning-protection performance function curve are both corrected to obtain a more realistic voltage difference, thus achieving reliable protection actions and state sensing of a lightning arrester on the line. An apparatus for limiting a lightning overvoltage of a direct-current power transmission line is further provided in the present invention to cooperate with the implementation of the method.

### CROSS-REFERENCE TO RELATED APPLICATIONS

This application is a continuation of International Patent Application No. PCT/CN2022/141786 with an international filing date of Dec. 26, 2022, designating the United States, now pending, and further claims foreign priority benefits to Chinese Patent Application No. 202211648056.9 filed on Dec. 21, 2022. The contents of all of the aforementioned applications, including any intervening amendments thereto, are incorporated herein by reference.

### TECHNICAL FIELD

The present invention belongs to the field of lightning protection for power transmission lines, and discloses a method, apparatus and system for limiting lightning overvoltage of a direct-current power transmission line, and a recording medium storing a program capable of executing the method.

### BACKGROUND

In recent years, direct-current (DC) transmission has developed rapidly in China. Lightning stroke has always been the primary cause of fault restart of DC transmission lines, accounting for about 50-60%, and the lightning-induced restart rate far exceeds the design and operation requirements. Against this background, China has developed ±400 kV-±1100 kV DC line lightning arresters to limit the lightning overvoltage of lines, and engineering applications have been realized, resulting in a certain degree of improvement in the lightning-induced restart rate of the lines.

DC transmission lines cover long distances, traversing complex environments with varying terrain, landforms, and climates. Currently, the lightning protection performance of the entire line is designed and calculated according to uniform standard procedures, without considering the impulse of different regions and environmental changes of the regions on the lightning protection performance parameters. The selection and design of line lightning arresters are solely based on lightning parameters, without considering the impact of the operating voltage of the line, which can lead to frequent actuation of the developed lightning arresters and reduced service life. Additionally, DC line lightning arresters adopt a pure air-clearance structure and are exposed to the atmospheric environment, thus being highly affected by the factors of altitude and climate. Therefore, multiple performance tests and verifications need to be conducted for lightning arresters used in different environments. Under conditions such as strong winds and heavy rains, when the line is struck by lightning, the lightning arrester may fail to actuate or malfunction. Moreover, these lightning arresters do not possess the function of monitoring their own status.

### SUMMARY

Aiming at the above problems, the present invention provides a method for limiting lightning overvoltage of a DC transmission line, including the following steps:

S1, acquiring static operation data of the DC transmission line and lightning current monitoring data of the line subjected to lightning strike through a monitoring instrument, wherein the static operation data includes voltage and current of the line not subjected to lightning strike, and the lightning current monitoring data includes lightning current amplitude, lightning current waveform and lightning strike time; superimposing the impact of the lightning current monitoring data on line operation onto the static operation data by electromagnetic transient simulation software to form dynamic operation data including voltage and current values; and establishing a coordinate system with time as a horizontal axis and the voltage of the dynamic operation data as a vertical axis to draw a line dynamic operation function curve;

S2, correcting lightning protection performance parameters of the DC power transmission line in real time according to environmental factor data, wherein the lightning protection performance parameters include an air clearance of a tower head at a line tower and a lightning impulse discharge voltage of a line insulator, and the environmental factor data includes topography, landforms, temperature, humidity, contamination level and air pressure values in the environment where the line is located; and establishing a coordinate system with time as the horizontal axis and the lightning impulse discharge voltage as the vertical axis to draw a line lightning protection performance function curve; and

S3, subtracting a voltage value on the line dynamic operation function curve from a voltage value on the line lightning protection performance function curve at any moment in the same coordinate system to obtain a voltage difference, and a lightning arrester arranged in the line activating discharge protection and recording discharge data of the lightning arrester when the voltage difference is less than 15%-20% of dynamic operating voltage at the moment.

Preferably, the lightning arrester includes a body unit and a clearance unit that are connected in sequence, wherein a sensing module is arranged in the body unit, and gas located between electrodes at both ends of a clearance in the clearance unit is sealed by an insulating material.

Preferably, line sections affected by lightning strike are sequentially divided into a safe area, a disturbance area and a hazardous area according to a spacing between the line dynamic operation function curve and the line lightning protection performance function curve at different positions from a lightning strike point, and a DC line lightning arrester is installed and arranged in the hazardous area.

Preferably, one end of the clearance unit of the lightning arrester is fixed to the line, and one end of the body unit is fixed to a tower cross arm above the line or to a tower below the line.

In order to cooperate with the above method for implementation, based on the same inventive idea, the present invention also provides an apparatus for limiting lightning overvoltage of a DC transmission line, including the following functional modules:
a data acquisition module, used for acquiring static operation data and lightning current monitoring data of the DC power transmission line;
an environmental monitoring module, used for acquiring environmental factor data around the DC power transmission line;
a data processing module, used for fitting the data obtained by the data acquisition module and the environmental monitoring module into the line dynamic operation function curve and the line lightning protection performance function curve, predicting a line dynamic operation function value at a next moment according to a dynamic operation function value at a current moment, and calculating a voltage difference in real time;
a sensing module, used for determining an activation/deactivation state of a discharging function of the lightning arrester according to the voltage difference, sensing states and parameters of the lightning arrester, and recording discharging data of the lightning arrester; and
a lightning arrester, in communication connection to the sensing module and fixed between the line and the tower.

Preferably, the lightning arrester includes a body unit and a clearance unit that are connected in sequence, wherein a sensing module is arranged in the body unit, and gas located between electrodes at both ends of a clearance in the clearance unit is sealed by an insulating material.

Preferably, line sections affected by lightning strike are sequentially divided into a safe area, a disturbance area and a hazardous area according to a spacing between the line dynamic operation function curve and the line lightning protection performance function curve at different positions from a lightning strike point, and the lightning arrester is only arranged in the hazardous area.

Preferably, one end of the clearance unit of the lightning arrester is fixed to the line, and one end of the body unit is fixed to a tower cross arm above the line or to a tower below the line.

Another solution of the present invention is to provide a non-transient readable recording medium for storing one or more programs including a plurality of instructions, wherein the instructions, when being executed, cause a processing circuit to perform the method for limiting lightning overvoltage of a DC power transmission line as described above.

The present invention also provides a system for limiting lightning overvoltage of a DC transmission line, including a processing circuit, and a memory electrically coupled the processing circuit, wherein the memory is configured to store at least one program including a plurality of instructions, and the processing circuit runs the program to perform the method for limiting lightning overvoltage of a DC power transmission line.

The present invention has the beneficial effects that:

1. Improvement in the operation and action reliability of the lightning arrester. The impact of static operation data on dynamic operation data of the DC transmission line subjected to lightning strike is fully considered, the line dynamic operation function curve is fitted, the design principle of the lightning impulse discharge voltage of the lightning arrester is optimized, the operation and action reliability of the lightning arrester is improved, and the distribution law of line overvoltage after lightning strike is mastered, which provides a basis for the division of line sections affected by lightning strike and the selection of lightning arrester installation points.

2. Mastering of real-time lightning protection parameters of lines in different environments. The lightning protection performance parameters of the DC transmission line are corrected in real time based on the topography, landforms, temperature, humidity, contamination level and air pressure values in the environment where the line is located, the line lightning protection performance function curve is fitted, the voltage difference is calculated in real time in combination with the line dynamic operation function curve, and the action state of the lightning arrester is evaluated.

3. Reduction in the testing workload and design difficulty of the lightning arrester. The clearance structure of the lightning arrester is enclosed within a confined space, and is not affected by altitude and climate factors, allowing convenient testing in low-altitude environments. After passing the test, the lightning arrester can be directly applied to various altitude regions, thus reducing the design and manufacturing difficulty of the lightning arrester, improving the universality of the lightning arrester, and avoiding unprotected or malfunctions when the lightning arrester is subjected to lightning strike under severe weather conditions such as strong winds and heavy rains.

4. Realization of visualization of the state of the lightning arrester. The changes in various state parameters before and after the lightning arrester is subjected to lightning strike are recorded, the real-time operating state of the lightning arrester is sensed, and the action characteristics of the lightning arrester are evaluated, which provides support for the life prediction and intelligent operation and maintenance of the lightning arrester.

### BRIEF DESCRIPTION OF THE DRAWINGS

FIG. 1 is a flowchart of a method for limiting lightning overvoltage of a DC transmission line;

FIG. 2 is a line voltage variation curve when a line is subjected to 30 kA negative lightning shielding failure without considering a line static operation function curve according to an embodiment of the present invention;

FIG. 3 is a line dynamic operation function curve when a line is subjected to 30 kA negative lightning shielding failure considering a line static operation function curve according to embodiment of the present invention;

FIG. 4 is a line voltage variation curve when a line is subjected to 50 kA negative lightning shielding failure without considering a line static operation function curve according to an embodiment of the present invention;

FIG. 5 is a line dynamic operation function curve when a line is subjected to 50 kA negative lightning shielding failure considering a line static operation function curve according to embodiment of the present invention;

FIG. 6 is a line dynamic operation function curve when a line is subjected to 20 kA negative lightning shielding failure after a lightning arrester is installed in the hazardous area of the line considering a line static operation function curve according to embodiment of the present invention;

FIG. 7 is a line dynamic operation function curve when a line is subjected to 30 kA negative lightning shielding failure after a lightning arrester is installed in the hazardous area of the line considering a line static operation function curve according to embodiment of the present invention;

FIG. 8 is a discharge current curve of lightning arrester when a line is subjected to 30 kA negative lightning shielding failure after a lightning arrester is installed in the hazardous area of the line considering a line static operation function curve according to embodiment of the present invention;

FIG. 9 is a line dynamic operation function curve when a line is subjected to 50 kA negative lightning shielding failure after a lightning arrester is installed in the hazardous area of the line considering a line static operation function curve according to embodiment of the present invention;

FIG. 10 is a discharge current curve of lightning arrester when a line is subjected to 50 kA negative lightning shielding failure after a lightning arrester is installed in the hazardous area of the line considering a line static operation function curve according to embodiment of the present invention;

FIG. 11 is a lightning protection performance function curve of the line corrected by environmental factors according to an embodiment of the present invention;

FIG. 12 is a diagram reflecting the change of a voltage difference between the dynamic operation function curve and the lightning protection performance parameter function curve of the line when the line is subjected to 30 kA negative lightning shielding failure considering a static operation function curve of the line according to the embodiment of the present invention;

FIG. 13 is a structural diagram of a DC line lightning arrester according to an embodiment of the present invention;

FIG. 14 is an internal structural diagram of a body unit of a lightning arrester according to an embodiment of the present invention;

FIG. 15 is an internal structural diagram of a clearance unit of a lightning arrester according to an embodiment of the present invention;

FIG. 16 shows an installation mode of a lightning arrester according to an embodiment of the present invention; and

FIG. 17 shows another installation mode of a lightning arrester according to an embodiment of the present invention;

wherein: 1—body unit; 2—clearance unit; 3—tower; 4—cross arm; 5—DC transmission line; 6—transmission line insulator; 1-1—data acquisition module; 1-2—environmental monitoring module; 1-3—data processing module; 1-4—sensing module; 2-1—upper electrode; 2-2—insulating support; 2-3—insulating sealing sleeve; and 2-4—lower electrode.

### DETAILED DESCRIPTIONS

In order to make the objects, technical solutions and advantages of the embodiments of the present invention more clear, the technical solutions of the embodiments of the present invention will be described below in conjunction with the accompanying drawings of the embodiments of the present invention, the described embodiments are some, but not all, of the embodiments of the present invention. On basis of the embodiments in the present invention, all other embodiments obtained by those skilled in the art without making inventive labor belong to the protection scope of the present invention.

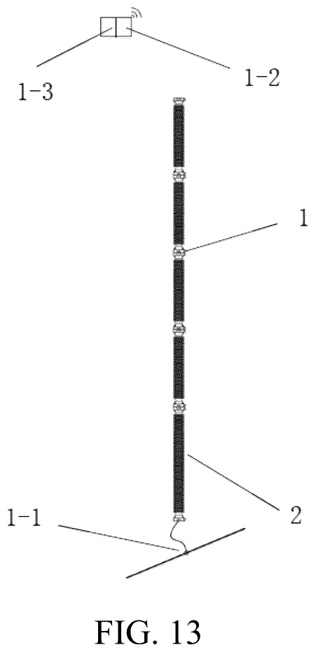

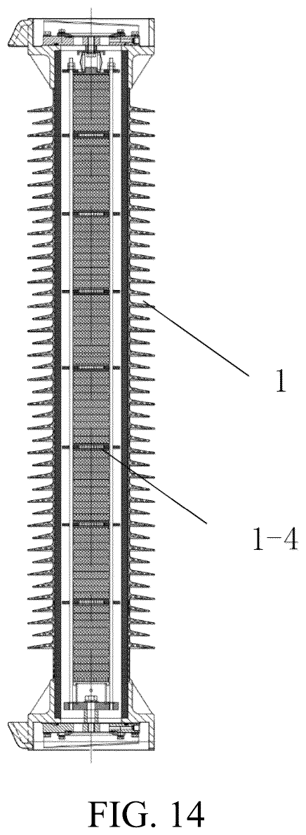

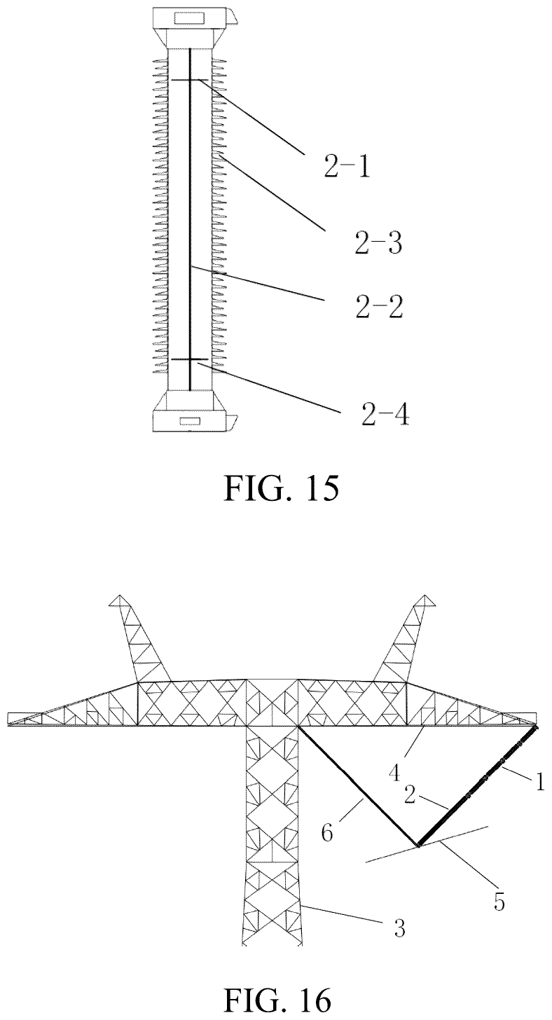

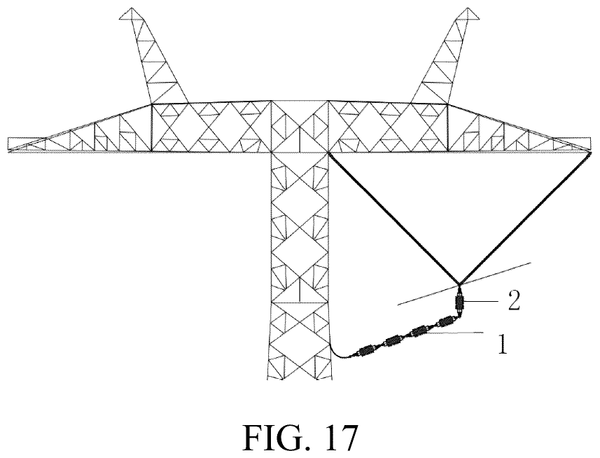

As shown in FIGS. 13-17, an embodiment of an apparatus for limiting lightning overvoltage of a DC transmission line includes the following functional modules:
a data acquisition module 1-1, used for acquiring static operation data and lightning current monitoring data of the DC transmission line;
an environmental monitoring module 1-2, used for acquiring environmental factor data around the DC transmission line;
a data processing module 1-3, used for fitting the data obtained by the data acquisition module and the environmental monitoring module into a line dynamic operation function curve and a line lightning protection performance function curve, predicting a line dynamic operation function value at the next moment according to a dynamic operation function value at the current moment, and calculating a voltage difference in real time; and
a sensing module 1-4, used for determining the activation/deactivation state of the discharge function of the lightning arrester according to the voltage difference, sensing the state and parameters of the lightning arrester and recording discharge data of the lightning arrester.

The apparatus further includes a lightning arrester in communication connection with the sensing module 1-4, and fixed between a DC transmission line 5 and a tower 3, the lightning arrester includes body units 1 and clearance units 2 that are connected in sequence, the sensing module 1-4 is located in the body unit 1, gas located between electrodes at both ends of a clearance in the clearance unit 2 is sealed by an insulating sealing sleeve 2-3, the insulating sealing sleeve is internally provided with an upper electrode 2-1, an insulating support 2-2 and a lower electrode 2-4, the upper electrode 2-1 and the lower electrode 2-4 are both fixedly mounted on the insulating support 2-2, and the clearance distance between the upper electrode 2-1 and the lower electrode 2-4 can be determined according to the requirements of lightning arresters with different voltage levels for lightning impulse discharge voltage and DC withstand voltage, or can be achieved by filling the interior with gases having different conductive properties. The line sections affected by lightning strike are sequentially divided into a safe area, a disturbance area and a hazardous area according to the spacing between the line dynamic operation function curve and the line lightning protection performance function curve at different positions from a lightning strike point, and the lightning arrester is only arranged in the hazardous area. One end of the clearance unit 2 of the lightning arrester is fixed to the line, the body unit 1 and the clearance unit 2 of the lightning arrester are rigidly connected, and one end of the body unit 1 is fixed to a tower cross arm 4 above the line, so that the function of the lightning arrester replacing the original right line insulator as a whole can be achieved; the body unit 1 and the clearance unit 2 of the lightning arrester can also be flexibly connected to form a lightning arrester similar to an AC line insulator support clearance lightning arrester, and one end of the body unit 1 is fixed to a tower below the line, which enables the first application of this installation method to DC power lines.

The detailed manner of calculating the functions in the module and the detailed operation method after the device of this embodiment is put into service is described in the following example of a method for limiting lightning overvoltage of a DC transmission line:

The main technical parameters of the extra high voltage DC transmission line lightning arrester selected in this embodiment are as follows:

| | | | | Parameter |
|---|---|---|---|---|
| Item | | | Unit | Value |
| System nominal voltage | | | kV | ±1100 |
| System highest operating voltage | | | kV | ±1122 |
| Nominal discharge current | | | kA, peak | 30 |
| | | | value | |
| Rated voltage (DC voltage) | | | kV | 1320 |
| Lightning | DC reference voltage | | kV | ≥1320 |
| arrester | Leakage current at 0.75 times DC reference voltage | | HA | ≤50 |
| body | Lightning impulse residual voltage | | kV, peak | ≤2450 |
| | | | value | |
| | Steep front impulse residual voltage | | kV, peak | ≤2695 |
| | | | value | |
| | 2 ms square wave impulse withstand current | | A, peak value | 2000 |
| | High current impulse withstand current | | kA, peak | 100 |
| | | | value | |
| | Minimum nominal creepage distance | | mm/kV | ≥25 |
| | Insulation | Rated lightning impulse withstand | kV, peak | 3430 |
| | resistance | voltage | value | |
| | performance | | | |
| | of composite | Rated 1 short-time 1-minute positive | kV | 1320 |
| | sheath | DC withstand voltage | | |
| | Short circuit | Rated short circuit current | kA, valid | 50 |
| | current | | value | |
| | withstand | Small current short circuit current | A, valid | 800 |
| | capability | | value | |

| | | |
|---|---|---|
| Positive lightning impulse 50% discharge voltage | kV, peak | ≤3300 |
| | value | |
| Positive switching impulse wet withstand voltage | kV, peak | 1683 |
| | value | |
| Rated short-time 1-minute positive DC wet withstand voltage | kV | 1320 |
| Rated short-time 1-minute positive DC wet withstand voltage | kV | 1190 |
| (for body fault) | | |

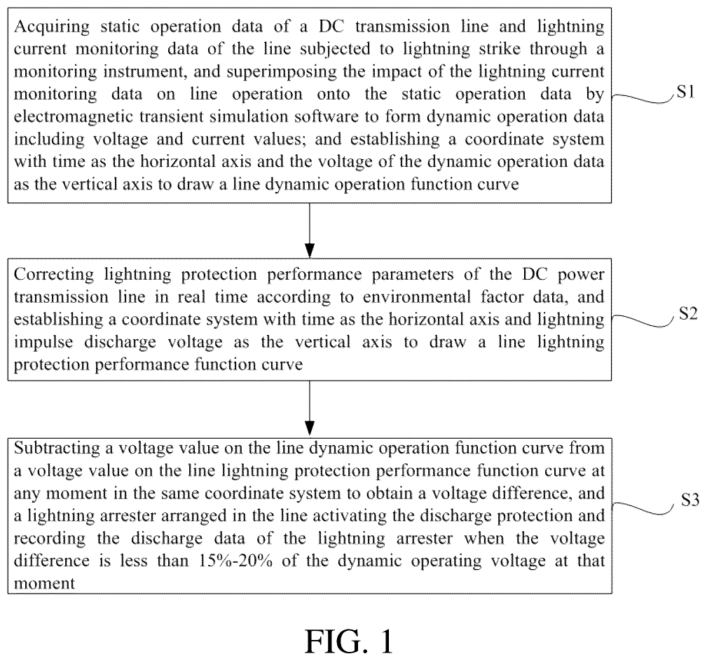

As shown in FIG. 1, firstly, static operation data of the DC transmission line and lightning current monitoring data of the line subjected to lightning strike are acquired through a monitoring instrument, wherein the static operation data includes voltage and current of the line not subjected to lightning strike, and the lightning current monitoring data includes lightning current amplitude, lightning current waveform and lightning strike time; the impact of the lightning current monitoring data on line operation is superimposed onto the static operation data by electromagnetic transient simulation software to form dynamic operation data including voltage and current values; and a coordinate system is established with taking time as the horizontal axis and the voltage of the dynamic operation data as the vertical axis, and a line dynamic operation function curve is drawn.

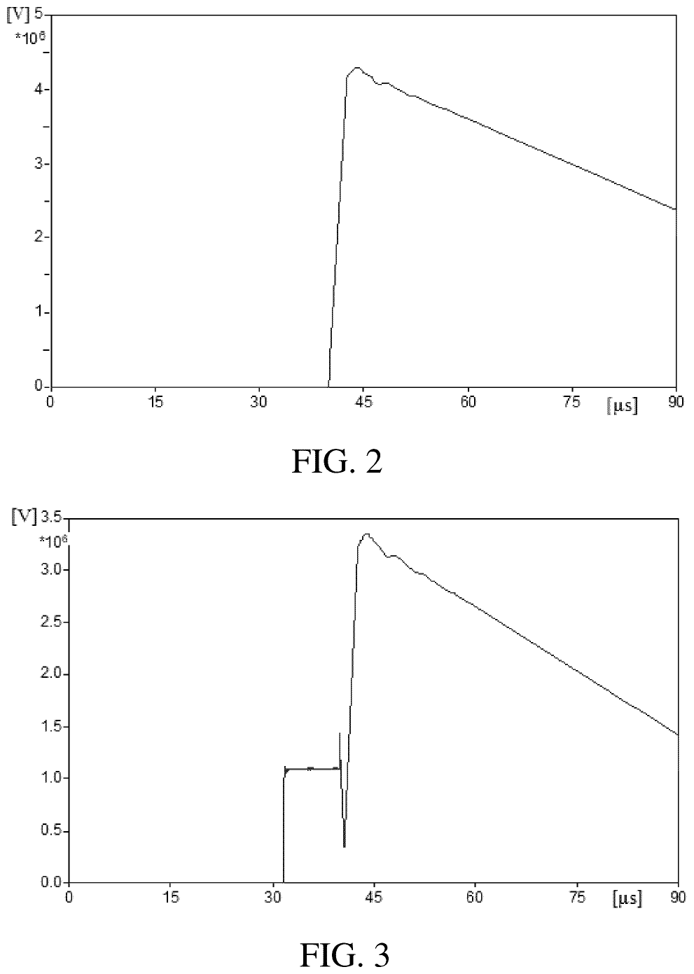

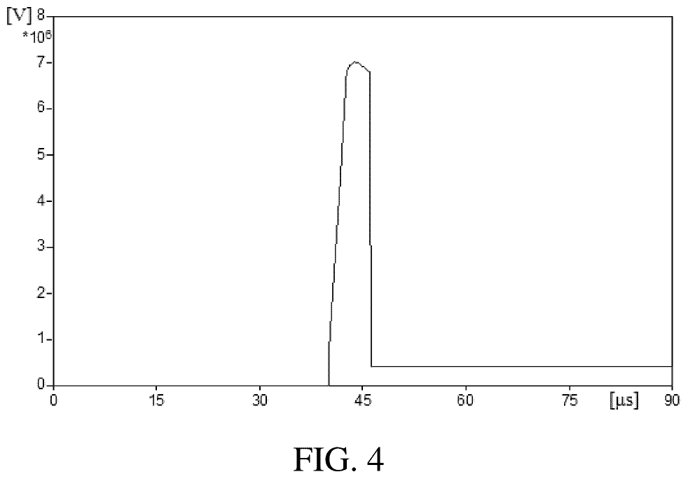

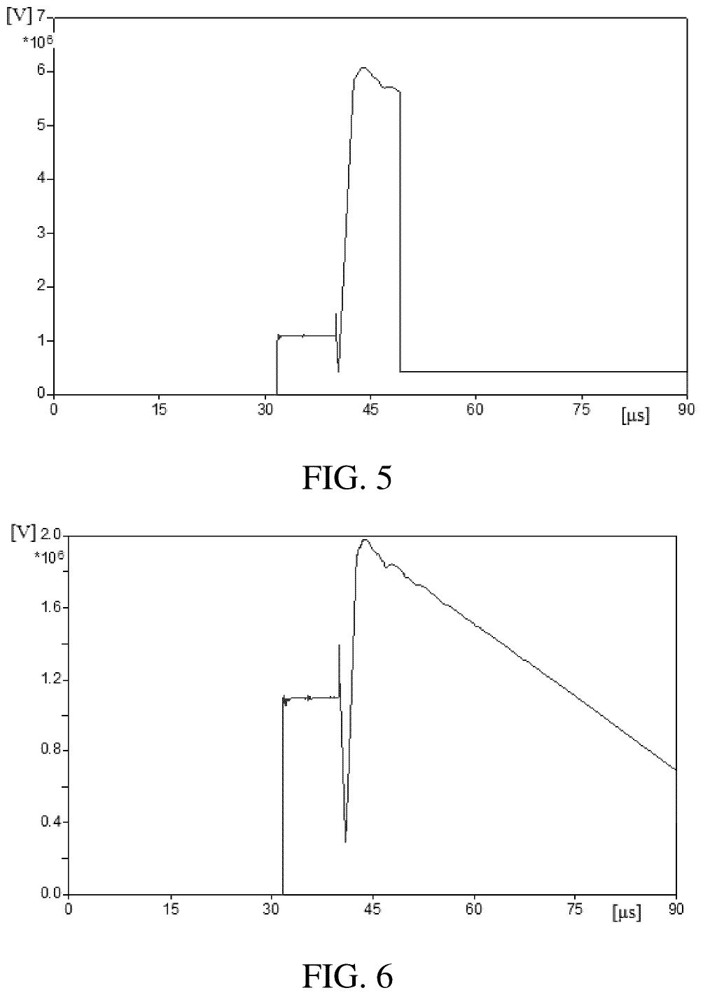

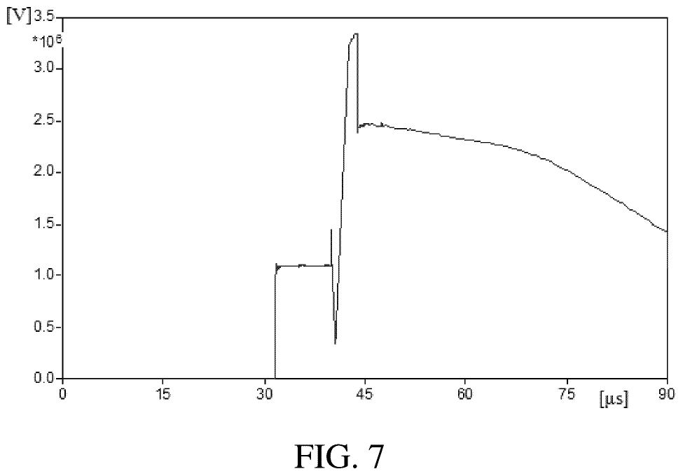

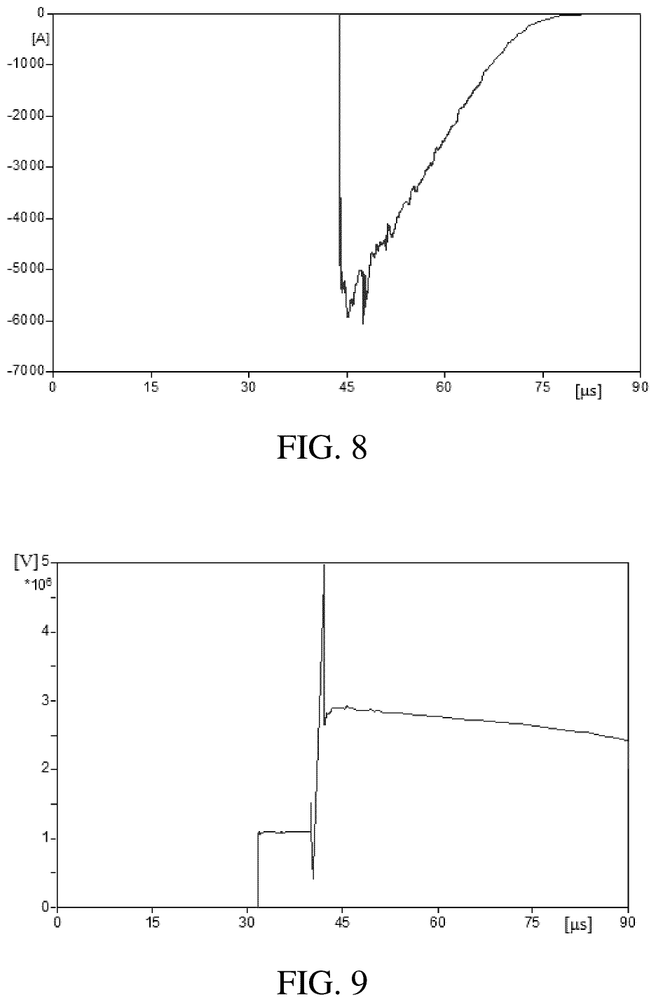

Specifically, as shown in FIGS. 2-9, line voltage variation curves when a line is subjected to 30 kA and 50 kA negative lightning shielding failure considering and without considering a line static operation function curve, line dynamic operation function curves when the line is subjected to 20 kA, 30 kA and 50 kA negative lightning shielding failure after a lightning arrester is installed in the hazardous area of the line considering a line static operation function curve, and a lightning arrester discharge current-voltage curve are drawn, respectively. As can be seen from FIG. 2, when the line static operation function curve is not considered, that is, when the working voltage of the line is 0, the line is subjected to 30 kA negative lightning shielding failure at 40 μs, and the lightning overvoltage reaches the peak value of 4295 kV at 43.6 μs, and then slowly drops, and the voltage curve does not suddenly drop to 0 in the whole process, indicating that no flashover occurs on the line due to 30 kA negative lightning shielding failure at this time. As can be seen from FIG. 3, when the line static operation function curve is considered, that is, the line has a working voltage of 1100 kV at 32 μs, the line is subjected to 30 kA negative lightning shielding failure at 40 μs, and the lightning overvoltage reaches a peak value of 3349 kV at 43.6 μs, which is 946 kV lower than that without considering the line static operation function curve, and then the lightning overvoltage curve slowly drops, and the voltage curve does not suddenly drop to zero in the whole process, indicating that no flashover occurs on the line due to 30 kA negative lightning shielding failure at this time. As can be seen from FIG. 4, when the line static operation function curve is not considered, that is, when the working voltage of the line is 0, the line is subjected to 50 kA negative lightning shielding failure at 40 μs, and the lightning overvoltage reaches a peak value of 7012 kV at 43.6 μs, and then the voltage drops sharply at 46.1 μs (it takes 2.5 μs), and the curve turns, indicating that a flashover occurs on the line due to 50 kA negative lightning shielding failure at this time. As can be seen from FIG. 5, when the line static operation function curve is considered, that is, the line has a working voltage of 1100 kV at 32 μs, the line is subjected to 50 kA negative lightning shielding failure at 40 μs, and the lightning overvoltage reaches a peak value of 6066 kV at 43.6 μs, which is 946 kV lower than that without considering the line static operation function curve, and then the voltage drops sharply at 49.3 μs (it takes 5.7 μs, delayed by 3.2 μs compared with the curve delay of without considering the line static operation function curve), the curve turns, indicating that a flashover occurs on the line due to 50 kA negative lightning shielding failure. As can be seen from FIG. 6, when the line static operation function curve is considered, that is, when the line has a working voltage of 1100 kV at 32 μs, the line is subjected to 20 kA negative lightning shielding failure at 40 μs, and the lightning overvoltage reaches a peak value of 1979 kV at 43.6 μs, and then the lightning overvoltage curve slowly decreases, and the voltage curve does not suddenly drop or turn, indicating that no flashover occurs on the line due to 20 kA negative lightning shielding failure at this time and the lightning arrester installed does not act and limit the lightning overvoltage of the line. As can be seen from FIG. 7, when the line static operation function curve is considered, that is, the line has a working voltage of 1100 kV at 32 μs, the line is subjected to 30 kA negative lightning shielding failure at 40 μs, and the lightning overvoltage reaches a peak value of 3349 kV at 43.6 μs, then the lightning overvoltage curve turns, and the value suddenly drops to 2454 kV, then the curve slowly drops, and the voltage curve does not suddenly drop to zero in the whole process, indicating that no flashover occurs on the line due to 30 kA negative lightning shielding failure at this time. As can be seen from FIG. 8, when the line static operation function curve is considered, that is, when the line has a working voltage of 1100 kV at 32 μs, the line is subjected to 30 kA negative lightning shielding failure at 40 μs, and a lightning overcurrent with a value of 6 kA passes through the lightning arrester at 43.6 μs, which is consistent with the time when the lightning overvoltage curve in FIG. 7 turns and its value suddenly drops to 2454 kV, indicating that the lightning arrester installed at this time has acted and limited the lightning overvoltage of the line. As can be seen from FIG. 9, when the line static operation function curve is considered, that is, when the line has a working voltage of 1100 kV at 32 μs, the line is subjected to 50 kA negative lightning shielding failure at 40 μs, and the lightning overvoltage reaches a peak value of 4844 kV at 42.3 μs, then the lightning overvoltage curve turns, and the value suddenly drops to 2650 kV, then the curve slowly drops, and the voltage curve does not suddenly drop to zero in the whole process, indicating that no flashover occurs on the line due to 50 kA negative lightning shielding failure at this time.

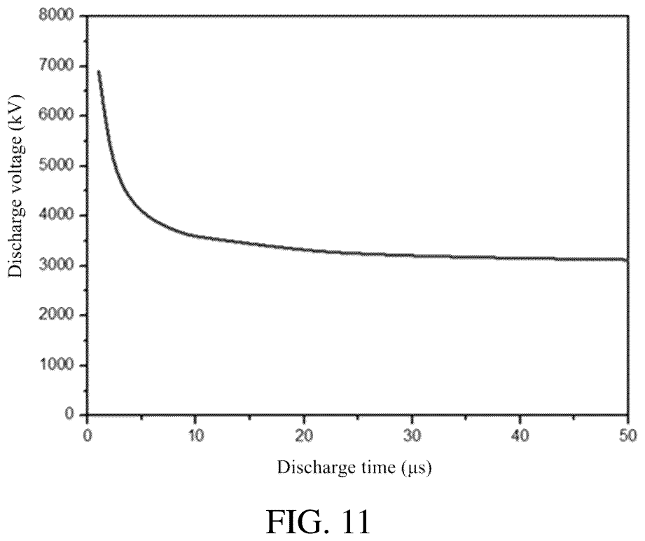

Lightning protection performance parameters of the DC power transmission line are corrected in real time according to the environmental factor data, wherein the lightning protection performance parameters include an air clearance of a tower head at a line tower and a lightning impulse discharge voltage of a line insulator, and the environmental factor data includes topography, landforms, temperature, humidity, contamination level and air pressure values in the environment where the line is located; a coordinate system is established with time as the horizontal axis and the lightning impulse discharge voltage as the vertical axis to draw the line lightning protection performance function curve (see FIG. 11).

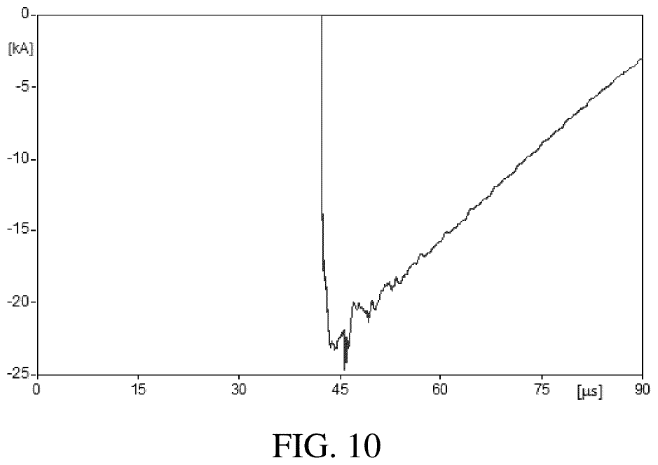

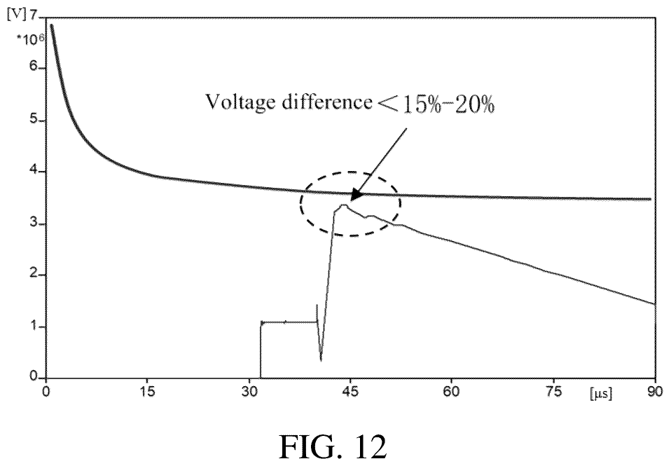

The line dynamic operation function curve and the line lightning protection performance function curve are integrated into the same coordinate system, a voltage value on the line dynamic operation function curve is subtracted from a voltage value on the line lightning protection performance function curve to obtain a voltage difference, when the voltage difference is less than 15%-20% of the dynamic operating voltage at that moment, see FIG. 12, the lightning arrester arranged in the line activates discharge protection, and discharge data, including leakage current, sustained current, lightning overcurrent, waveform, residual voltage, absorbed energy and internal temperature rise, of the lightning arrester is recorded, and a discharge current curve of lightning arrester is shown in FIG. 10.

It should be understood by those skilled in the art that embodiments of the present invention can be provided as methods, systems, or computer program products. Therefore, the present invention can adopt embodiments taking the form of an entirely hardware embodiment, an entirely software embodiment, or an embodiment combining software and hardware. Furthermore, the present invention can take the form of a computer program product implemented on one or more computers and available storage media (including but not limited to disk storage, CD-ROM, optical storage, etc.) in which computer usable program codes are embodied.

The present invention is described with reference to flowcharts and/or block diagrams of methods, devices (systems) and computer program products according to embodiments of the present invention. It should be understood that each flow and/or block in the flowchart and/or block diagram, and combinations of the flow and/or block in the flowchart and/or block diagram can be implemented by computer program instructions. These computer program instructions can be provided to a processor of a general-purpose computer, special-purpose computer, embedded processor or other programmable data processing device to produce a machine, such that the instructions which are executed by the processor of the computer or other programmable data processing device produce an apparatus for implementing the functions specified in one or more flows of the flowchart and/or one or more blocks of the block diagram.

These computer program instructions can also be stored in a computer-readable memory that can direct a computer or other programmable data processing device to function in a particular manner, such that the instructions stored in the computer-readable memory produce an article of manufacture including instruction apparatuses that implement the functions specified in one or more flows of the flowchart and/or one or more blocks of the block diagram.

These computer program instructions can also be loaded onto a computer or other programmable data processing device, such that a series of operational steps are performed on the computer or other programmable device to produce computer-implemented processing, such that the instructions executed on the computer or other programmable device provide steps for implementing the functions specified in one or more flows of the flowchart and/or one or more blocks of the block diagram.

Compiling the above method steps into a program and then storing the program in a hard disk or other non-transient storage media constitute an embodiment of the non-transient readable recording medium of the present invention; the storage medium is electrically connected to the computer processor, and the limitation of overvoltage of the line subjected to lightning strike can be completed through data processing, which constitutes the embodiment of the “system for limiting lightning overvoltage of a DC transmission line” of the present invention.

Finally, it should be explained that the above embodiments are only the preferred embodiments of the present invention, and are not used to limit the present invention. Although the present invention has been described in detail with reference to the foregoing embodiments, it is still possible for a person skilled in the art to modify the technical solution described in the foregoing embodiments or to equivalent replace some technical features. Any modification, equivalent substitution, improvement, and the like made within the spirit and principle of the present invention should be included in the protection scope of the present invention.

What is claimed is:

1. A method for limiting lightning overvoltage of a direct current power transmission line, comprising:
S1, acquiring static operation data of the direct current transmission line and lightning current monitoring data of the line subjected to lightning strike through a monitoring instrument, wherein the static operation data comprises voltage and current of the line not subjected to lightning strike, and the lightning current monitoring data comprises lightning current amplitude, lightning current waveform and lightning strike time; superimposing an impact of the lightning current monitoring data on line operation onto the static operation data by electromagnetic transient simulation software to form dynamic operation data comprising voltage and current values; and establishing a coordinate system with time as a horizontal axis and the voltage of the dynamic operation data as a vertical axis to draw a line dynamic operation function curve;
S2, correcting lightning protection performance parameters of the direct current power transmission line in real time according to environmental factor data, wherein the lightning protection performance parameters comprise an air clearance of a tower head at a line tower and a lightning impulse discharge voltage of a line insulator, and the environmental factor data comprises topography, landforms, temperature, humidity, contamination level and air pressure values in an environment where the line is located; and establishing a coordinate system with time as the horizontal axis and the lightning impulse discharge voltage as the vertical axis to draw a line lightning protection performance function curve; and
S3, subtracting a voltage value on the line dynamic operation function curve from a voltage value on the line lightning protection performance function curve at any moment in the same coordinate system to obtain a voltage difference, and a lightning arrester arranged in the line activating discharge protection and recording discharge data of the lightning arrester when the voltage difference is less than 15%-20% of dynamic operating voltage at the moment.

2. The method for limiting lightning overvoltage of a direct current power transmission line according to claim 1, wherein the lightning arrester comprises a body unit and a clearance unit that are connected in sequence, wherein a sensing module is arranged in the body unit, and gas located between electrodes at both ends of a clearance in the clearance unit is sealed by an insulating material.

3. The method for limiting lightning overvoltage of a direct current power transmission line according to claim 1, wherein line sections affected by lightning strike are sequentially divided into a safe area, a disturbance area and a hazardous area according to a spacing between the line dynamic operation function curve and the line lightning protection performance function curve at different positions from a lightning strike point, and a direct current line lightning arrester is installed and arranged in the hazardous area.

4. The method for limiting lightning overvoltage of a direct current power transmission line according to claim 2, wherein one end of the clearance unit of the lightning arrester is fixed to the line, and one end of the body unit is fixed to a tower cross arm above the line or to a tower below the line.

5. An apparatus for limiting lightning overvoltage of a direct current power transmission line, comprising the following functional modules that are in communication connection:
a data acquisition module, used for acquiring static operation data and lightning current monitoring data of the direct current power transmission line;
an environmental monitoring module, used for acquiring environmental factor data around the direct current power transmission line;
a data processing module, used for fitting the data obtained by the data acquisition module and the environmental monitoring module into the line dynamic operation function curve and the line lightning protection performance function curve, predicting a line dynamic operation function value at a next moment according to a dynamic operation function value at a current moment, and calculating a voltage difference in real time;
a sensing module, used for determining an activation/deactivation state of a discharging function of the lightning arrester according to the voltage difference, sensing states and parameters of the lightning arrester, and recording discharging data of the lightning arrester; and
a lightning arrester, in communication connection to the sensing module and fixed between the line and the tower.

6. The apparatus for limiting lightning overvoltage of a direct current power transmission line according to claim 5, wherein the lightning arrester comprises a body unit and a clearance unit that are connected in sequence, wherein a sensing module is arranged in the body unit, and gas located between electrodes at both ends of a clearance in the clearance unit is sealed by an insulating material.

7. The apparatus for limiting lightning overvoltage of a direct current power transmission line according to claim 5, wherein line sections affected by lightning strike are sequentially divided into a safe area, a disturbance area and a hazardous area according to a spacing between the line dynamic operation function curve and the line lightning protection performance function curve at different positions from a lightning strike point, and the lightning arrester is only arranged in the hazardous area.

8. The apparatus for limiting lightning overvoltage of a direct current power transmission line according to claim 6, wherein one end of the clearance unit of the lightning arrester is fixed to the line, and one end of the body unit is fixed to a tower cross arm above the line or to a tower below the line.
